(19) United States
(12) Patent Application Publication
(10) Pub. No.: US 2026/0238912 A1
(43) Pub. Date: Aug. 13, 2026

(54) MANAGING USAGE OF COMPONENTS OF AN AUDIO COMMUNICATION DEVICE IN STEREO AND MONO MODES

(71) Applicant: Motorola Mobility LLC, Chicago, IL (US)

(72) Inventors: Amit Kumar Agrawal, Bangalore (IN); Himanshu Chug, Bangalore (IN); Satyabrata Rout, Bangalore (IN)

(73) Assignee: Motorola Mobility LLC, Chicago, IL (US)

(21) Appl. No.: 19/050,711

(22) Filed: Feb. 11, 2025

(51) Int. Cl. H04R 1/10; H04R 5/033

(52) U.S. Cl. CPC H04R 1/1041; H04R 1/1016; H04R 5/033; H04R 2420/07

(57) ABSTRACT

An electronic device may determine that a first component and a second component of an audio communication device are wirelessly connected to the electronic device for operation in a stereo mode. The audio communication device may be wireless earbuds, where the first component and the second component are firs and second earbuds, respectively. Based on past usage of the audio communication device by a user, the electronic device may determine that the user prefers to use the first component in a mono mode, and that the second component is the user's non-preferred component in the mono mode. The electronic device may select the second component as a primary component for use in the stereo mode and the first component as a secondary component for use in the stereo mode, in part based on the user's preferred component in the mono mode.

### BACKGROUND

As technology has advanced our uses for computing devices have expanded. One such use is listening to audio through wearable audio communication devices such as earbuds. However, such wearable audio devices are not without their problems. One such problem is managing battery life of status of each component (e.g., earbud) of a wearable audio device, which can be frustrating to users and degrade their listening experience.

### BRIEF DESCRIPTION OF THE DRAWINGS

Embodiments of managing usage of components of an audio communication device in stereo and mono modes are described with reference to the following drawings. The same numbers are used throughout the drawings to reference like features and components:

FIG. 1 illustrates an example system for managing usage of components of an audio communication device in stereo and mono modes, as discussed herein;

FIG. 2 illustrates an example audio communication device implementing the techniques discussed herein;

FIGS. 3 and 4 illustrate example operations of the techniques discussed herein;

FIGS. 5 and 6 illustrate example use cases of wearable audio communication devices implementing the techniques discussed herein;

FIG. 7 illustrates an example process for implementing the techniques discussed herein in accordance with one or more embodiments;

FIG. 8 illustrates various components of an example electronic device that can implement embodiments of the techniques discussed herein.

### DETAILED DESCRIPTION

Managing usage of components of an audio communication device in stereo and mono modes is discussed herein. Generally, an audio communication device may be an Internet-of-Things (IoT) device or any other wearable audio device, such as a pair of wireless earbuds. Wireless earbuds may include a first earbud (e.g., a first component) and a second earbud (e.g., a second component). Battery life is a crucial aspect of such IoT devices, and the success of such IoT devices depends on long-lasting battery life. For example, some earbuds may communicate audio via a Bluetooth True Wireless Stereo (TWS) connection. In a Bluetooth TWS connection, one earbud may act as a primary earbud, and the other earbud may act as a secondary earbud. The primary earbud may be wirelessly connected with an electronic device (e.g., a smartphone) to receive left and right channel audio and sync the audio with the secondary earbud.

Because of the primary earbud's additional connection with the electronic device, the battery level of the primary earbud discharges faster than that of the secondary earbud in most cases. As such, the primary earbud may run out of battery and the user may be unable to enjoy a stereo listening experience with only a single earbud (e.g., the secondary earbud). Techniques are desired to improve the battery life of the earbuds and other similar IoT devices, and specifically to improve the additional load on the primary earbud (e.g., the connection to the electronic device) to enable the primary earbud to operate in symmetry with the secondary earbud in terms of battery status.

In contrast to traditional battery management of wireless earbuds, the techniques discussed herein support managing usage and battery levels of individual earbuds (e.g., components of an audio communication device) in both a stereo mode and a mono mode to improve the users' listening experience. In one or more implementations, an electronic device (e.g., a mobile device such as a smartphone) may determine that a first earbud (e.g., a first component) and a second earbud (e.g., a second component) of a set of wireless earbuds (e.g., an audio communication device) are wirelessly connected to the electronic device. The earbuds and the electronic device may be connected via a Bluetooth communication for operation in a stereo mode.

Based on the user's past usage of the earbuds, the electronic device may determine that the first earbud is the user's preferred component and the second earbud is the user's non-preferred component of the earbuds in a mono mode. That is, when the user listens to audio using only one earbud (e.g., so that they may still listen to their surroundings simultaneously), the user may prefer to use the left earbud more than the right earbud. Because the user uses the first earbud more often than the second earbud in the mono mode, the battery level of the first earbud may deplete faster than the battery level of the second earbud. Accordingly, the electronic device may select the second earbud as a primary component and the first earbud as a secondary component for use in the stereo mode. Because the primary component in the stereo mode is wirelessly connected to the electronic device to receive audio, the described techniques balance the overall battery levels of the earbuds more evenly.

The techniques discussed herein improve the operation of an electronic device and an audio communication device by balancing the battery level on each earbud of a pair of wearable earbuds based on enabling both earbuds to be primary components in different modes of operation (e.g., stereo or mono). Specifically, the discussed techniques extend the users' usage of the earbuds and balance the battery levels of the earbuds by selecting an earbud that is not primarily used in a mono mode as the primary earbud for a stereo mode. In this way, the discussed techniques enable a user to use a single earbud in the mono mode without the degrading the quality of later listening in the stereo mode, which may improve the user's overall listening experience and the battery life of the earbuds as a pair.

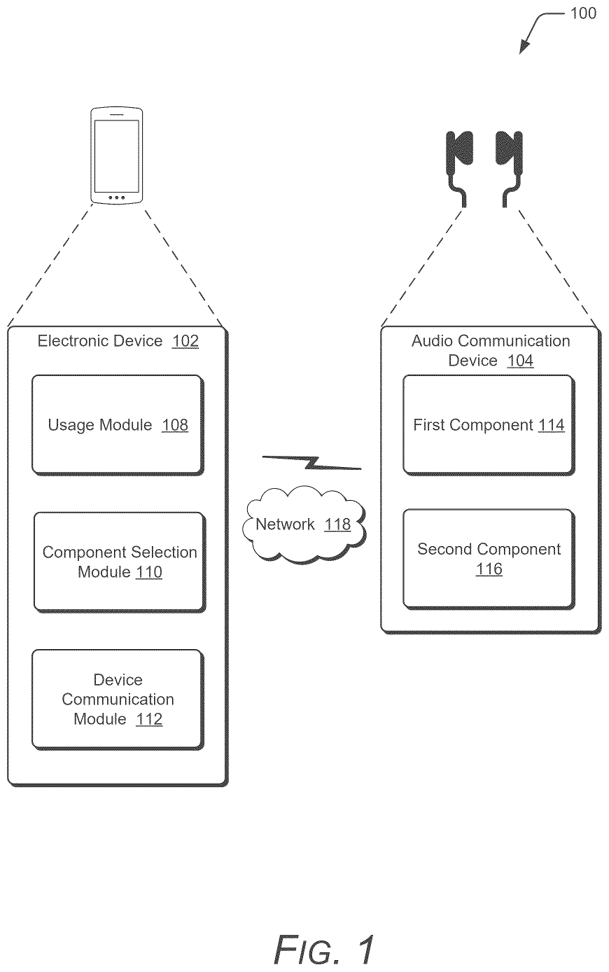

FIG. 1 illustrates an example system 100 implementing the techniques discussed herein. The system may include an electronic device 102 and an audio communication device 104 for managing usage of components of the audio communication device in stereo and mono modes. The electronic device 102 can be, or include, many different types of computing or electronic devices. For example, the electronic device 102 can be a smartphone or other wireless phone, a camera (e.g., compact or single-lens reflex), or a tablet or phablet computer. By way of further example, the electronic device 102 can be a notebook computer (e.g., netbook or ultrabook), a laptop computer, a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an IoT device, an automotive computer, and so forth.

The electronic device 102 may include a display. The display can be configured as any suitable type of display, such as an organic light-emitting diode (OLED) display, active matrix OLED display, liquid crystal display (LCD), in-plane shifting LCD, projector, and so forth. It should be noted that the display can be implemented as a part of the electronic device 102 or separately from the electronic device 102. In such situations, the electronic device 102 can communicate with the display via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. The display can also optionally operate as an input device (e.g., the display can be a touchscreen display).

The electronic device 102 may also include a processing system that includes one or more processors, each of which can include one or more cores. The processing system is coupled with, and may implement functionalities of, any other components or modules of the electronic device 102 that are described herein. In one or more embodiments, the processing system includes a single processor having a single core. Alternatively, the processing system includes a single processor having multiple cores or multiple processors (each having one or more cores).

The electronic device 102 may also include an operating system. The operating system manages hardware, software, and firmware resources in the electronic device 102. The operating system may manage one or more applications running on the electronic device 102 and operate as an interface between applications and hardware components of the electronic device 102.

The audio communication device 104 can be, or include, many different types of audio communication devices. For example, the audio communication device 104 can be an IoT device, wireless (e.g., TWS) earbuds, a wireless headset, wireless earbuds with a cable, wired earbuds, and so forth. As described in the system 100, the audio communication device 104 is an example of wireless earbuds.

The audio communication device 104 may include a first component 114 and a second component 116. For example, the audio communication device 104 may include two earbuds, a left earbud and a right earbud, and where the first component 114 may be the left or right earbud and the second component 116 may be the other of the left or right earbud. The audio communication device 104 may also include a case or other component for holding and in some cases, charging the first component 114 and the second component 116. The audio communication device 104 may support audio communications in a stereo mode and a mono mode. In a stereo mode, a user may wear both the first component 114 and the second component 116 of the audio communication device 104 and receive audio through two audio channels (e.g., a left channel and a right channel) corresponding to each of the components. In a mono mode, the user may wear only one of the first component 114 or the second component 116 and receive audio through a single corresponding audio channel, which may create a more focused, narrow sound image than in the stereo mode. For example, the user may use the mono mode to listen to music while still being aware of their surroundings.

The electronic device 102 may include a usage module 108 that implements functionality to determine whether the audio communication device 104 is connected to the electronic device 102. For example, the electronic device 102 may determine that the first component 114 and the second component 116 are wirelessly connected to the electronic device 102 for operation in the stereo mode. The electronic device 102 may be connected to the audio communication device 104 via a Bluetooth communication.

The usage module 108 may also implement functionality to determine how the user uses the audio communication device 104. Based on the user's past or previous usage of the audio communication device 104, the electronic device 102 may determine whether the user typically prefers the first component 114 or the second component 116 in the mono mode. For example, the user's past usage may indicate that the user typically prefers to wear the first component 114 in the mono mode, making the second component 116 the user's non-preferred component in the mono mode. In some examples, the usage module 108 may support some type of data store that allows the electronic device 102 to store past usage data. This enables the electronic device 102 to keep track of how often the user has preferred the first component 114 or the second component 116 when using the audio communication device 104 in the mono mode in the past.

The usage module 108 may determine the first component 114 or the second component 116 is operating in the stereo mode or in the mono mode in various different manners. For example, the first component 114 or the second component 116 may transmit an indication to the electronic device 102 whether that component is operating in the stereo mode or in the mono mode. By way of another example, the user of the electronic device 102 may provide user input to the electronic device 102 indicating whether the first component 114 or the second component 116 is operating in the stereo mode or in the mono mode.

In some examples, when the audio communication device is used in a stereo mode, a setting may be coded in the device's firmware indicating which component is to be used as the primary component and which component is to be used as the secondary component in the stereo mode by default. This default setting is then sent to the electronic device 102 when the audio communication device 104 is used in the stereo mode. To determine which of the component is being used in the mono mode, for example, the components may detect whether they are in a case (e.g., a charging case of the audio communication device 104) or out of the case. If a component is out of the case, the user may be using the component in a mono mode. This information may be sent to the electronic device 102. By way of another example, the components may include cap sensors which may detect in-ear presence (e.g., that the component is in the user's ear). If only one component is sending information to the electronic device 102 about in-ear detection, the electronic device 102 may determine that component is the component being used in the mono mode.

The electronic device 102 may also include a component selection module 110, which may implement functionality to select a component of the audio communication device 104 to be a primary component. That is, if the user switches from listening in the mono mode to listening in the stereo mode, the component selection module 110 may select a primary component for the stereo mode based on which component was determined to be the preferred component in the mono mode based on the past usage. If the first component 114 is the user's preferred component in the mono mode, then the component selection module 110 may select the second component 116 as a primary component and the first component 114 as the secondary component for use in the stereo mode. Alternatively, if the second component 116 is the user's preferred component in the mono mode, then the component selection module 110 may select the first component 114 as a primary component and the second component 116 as the secondary component for use in the stereo mode. In this way, the electronic device 102 may preserve the battery level of the user's preferred earbud during stereo mode operation by making the preferred earbud the secondary earbud, which allows the user to make maximum use of the preferred earbud during mono mode operation.

The electronic device 102 may also include a device communication module 112 that implements functionality to communicate with the audio communication device 104 (e.g., send and receive various signals, data, and so forth). The electronic device 102 and the audio communication device 104 can be connected to one another using one or more of a wired or wireless connection. The electronic device 102 and the audio communication device 104 can be directly connected to one another (e.g., with no intermediary device or system) or indirectly connected to one another (e.g., via one or more other devices or systems such as a router, switch, hub, wireless access point, and so forth). The audio communications between the electronic device 102 and the audio communication device 104 can take various forms, such as music, a phone call, other web audio content (e.g., podcasts, videos), and so forth, and can be carried out over a network 118, which may support a wireless Bluetooth connection between the devices.

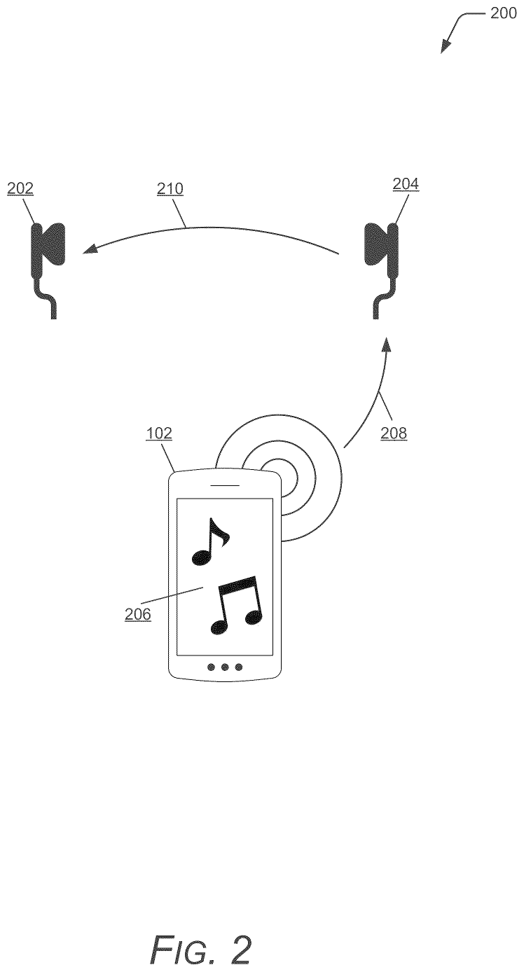

FIG. 2 illustrates an example of an audio communication device 200 implementing the techniques discussed herein. The audio communication device 200 may be an example of the audio communication device 104 described with reference to FIG. 1. The audio communication device 200 may include a pair of wireless earbuds including an earbud 202 and an earbud 204. In some examples, the earbud 202 may be a left earbud and the earbud 204 may be a right earbud. Alternatively, the earbud 202 may be a right earbud and the earbud 204 may be a left earbud. In some examples, a user may wear either earbud in either ear and experience the same quality of audio.

A user may connect the earbud 202 and the earbud 204 to an electronic device 102 (e.g., a smartphone) to listen to music 206, videos, or podcasts, talk on the phone, participate in a video conference, and so forth. The electronic device may connect to the earbuds via a wireless connection 208, such as a Bluetooth connection. Specifically, the electronic device may connect to a primary earbud. In the example of FIG. 2, the earbud 204 may be a primary earbud. As such, the earbud 204 may receive left and right channel audio from the electronic device and sync with the earbud 202, a secondary earbud to provide the audio via both audio channels. The earbud 202 and the earbud 204 may be connected via a wireless connection 210, which may be a Bluetooth connection. In some examples, a user may wear both the earbud 202 and the earbud 204 for stereo mode operations, in which case audio is provided through both the right and left channels (e.g., via the earbud 202 and the earbud 204). Alternatively, a user may wear only one of the earbuds for mono mode operations, in which case audio is provided through a single channel via the earbud 204 (e.g., the primary earbud).

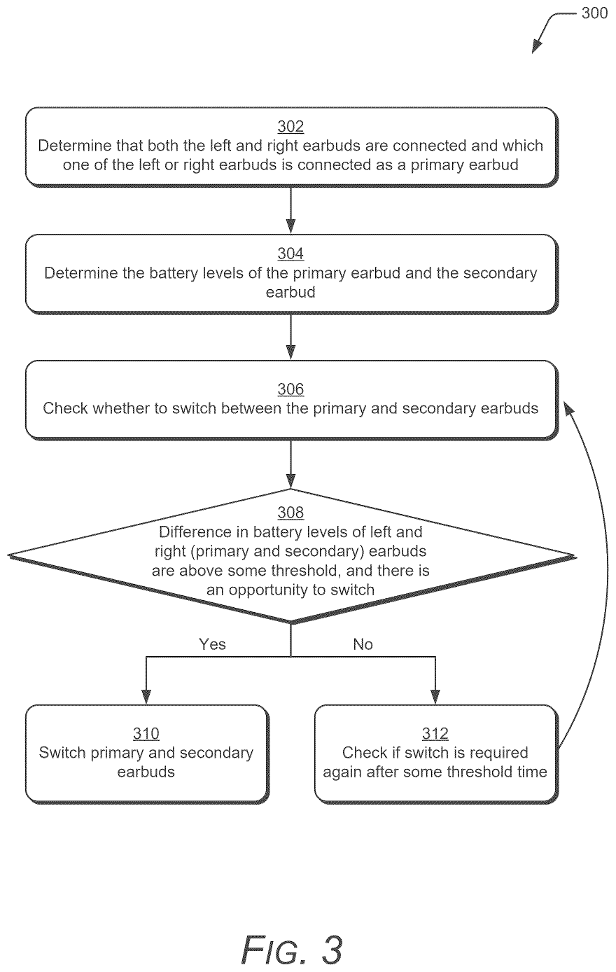

FIG. 3 illustrates an example operation 300 implementing the techniques discussed herein. The operation 300 may be implemented in or otherwise supported by the system 100, as described with reference to FIG. 1. For example, the operation 300 may enable an electronic device 102 to manage the usage of components (e.g., earbuds) of an audio communication device 104 in stereo and mono modes. The operation 300 illustrates an example of the techniques discussed herein, though steps of the operation 300 may be performed in different orders.

At 302, an electronic device (e.g., a mobile device such as a smartphone) may determine that both left and right (e.g., first and second) earbuds are connected to the electronic device. For example, the earbuds may be TWS earbuds connected to the electronic device via Bluetooth. The electronic device may also determine which one of the left or right earbuds is connected to the electronic device as the primary earbud for a stereo mode. The primary earbud may connect to the electronic device directly, receive audio through left and right audio channel, and sync with a secondary earbud to provide the audio through both of the channels.

At 304, the electronic device may determine the battery levels of the primary and secondary earbuds. In some examples, the electronic device may be equipped with the ability to monitor the battery levels of the earbuds while a user is wearing the earbuds and determine a potential difference between the battery levels of the earbuds. Additionally, or alternatively, the electronic device may determine the battery levels based on receiving an indication of the battery levels. For example, a user may store the earbuds in a charging case when not in use, where the charging case may measure the battery levels of the earbuds and provide the battery levels to the electronic device (given the electronic device and the charging case are connected via a wired connection or a wireless connection such as Bluetooth).

At 306, the electronic device may check whether to switch between the primary and secondary earbuds. For example, the electronic device may determine to switch between the primary and secondary earbuds based on the battery levels of the earbuds. Additionally, or alternatively, the electronic device may determine to switch between the primary and secondary earbuds based on the user switching from using the earbuds in a mono mode to a stereo mode or from the stereo mode to the mono mode.

At 308, the electronic device may determine both whether the difference in battery levels of the earbuds is above some threshold (e.g., a percentage), and if there is an opportunity to switch the earbuds. An opportunity to switch the earbuds is referred to as a triggering event, which may be an opportune moment that will not disturb the user's listening experience, such as the completion of a music track (e.g., before a new song starts), during a pause detected during a phone call, and so forth.

At 310, if the difference between the battery levels of the earbuds is above the threshold (e.g., if the difference is large enough) and there is an opportunity to switch the earbuds (e.g., during a pause during a phone call), then the electronic device may switch the primary and secondary earbuds. For example, if the left earbud is initially the primary earbud and the right earbud is initially the secondary earbud for the stereo mode, then the electronic device may switch the earbuds such that the right earbud is the primary earbud and the left earbud is the secondary earbud for subsequent audio communication. Alternatively, if the right earbud is initially the primary earbud and the left earbud is initially the secondary earbud for the stereo mode, then the electronic device may switch the earbuds such that the left earbud is the primary earbud and the right earbud is the secondary earbud for subsequent audio communication. Switching the earbuds in this way will ensure that the battery levels of the earbuds deplete more evenly, providing the user more listening time and a higher-quality stereo listening experience.

If the connection between the electronic device and the earbuds is fresh (e.g., if the electronic device and the earbuds are connecting for the first time, if both the earbuds are fully charged, etc.), then the electronic device may select either the left earbud or the right earbud as the primary bud based on which of the left or right earbud has the higher battery level compared to the other of the left or right earbud. That is, in a new connection, of the left earbud has even a slightly higher battery level than the right earbud, then the electronic device may select the left earbud as the primary earbud.

Alternatively, at 312, if the difference between the battery levels of the earbuds is below the threshold (e.g., if the difference is not large enough) and/or if there is no opportunity to switch the earbuds, then the electronic device may refrain from switching the primary and secondary earbuds. For example, if the left earbud is initially the primary earbud and the right earbud is initially the secondary earbud for the stereo mode, then the electronic device may maintain the left earbud as the primary earbud and the right earbud as the secondary earbud. After some period of time, the electronic device may again check if a switch between the primary and secondary earbuds is required based on the battery levels of the earbuds (e.g., repeat 306 and 308).

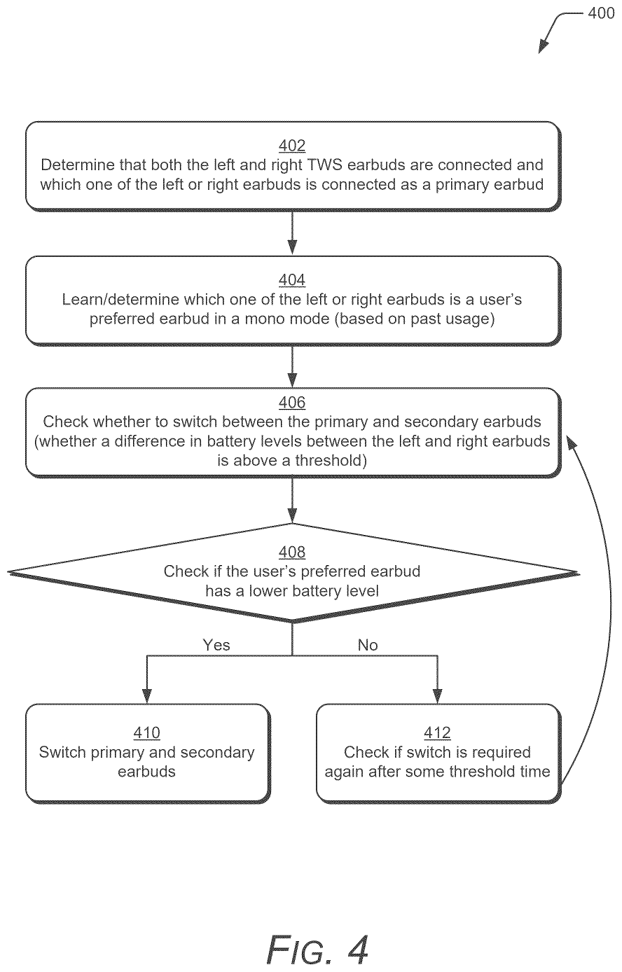

FIG. 4 illustrates an example operation 400 implementing the techniques discussed herein. The operation 400 may be implemented in or otherwise supported by the system 100, as described with reference to FIG. 1. For example, the operation 400 may enable an electronic device 102 to manage the usage of components (e.g., earbuds) of an audio communication device 104 in stereo and mono modes. The operation 400 illustrates an example of the techniques discussed herein, though steps of the operation 400 may be performed in different orders.

At 402, an electronic device (e.g., a mobile device such as a smartphone) may determine that both left and right (e.g., first and second) earbuds are connected to the electronic device. For example, the earbuds may be TWS earbuds connected to the electronic device via Bluetooth. The electronic device may also determine which one of the left or right earbuds is connected to the electronic device as the primary earbud for a stereo mode. The primary earbud may connect to the electronic device directly, receive audio through left and right audio channel, and sync with a secondary earbud to provide the audio through both of the channels.

At 404, based on a user's past usage of the earbuds, the electronic device may learn or determine which one of the left earbud or the right earbud is the user's preferred earbud in a mono mode (e.g., single bud operation). That is, the electronic device may determine whether the user typically prefers to wear the left earbud only or the right earbud only when listening to audio in a mono mode. In some examples, the electronic device may determine the preferred earbud based on past usage data that is stored at the electronic device.

At 406, the electronic device may check whether to switch between the primary and secondary earbuds. For example, the electronic device may determine to switch between the primary and secondary earbuds based on the battery levels of the earbuds. In such cases, the electronic device may check whether a difference between the battery level of the left earbud and the battery level of the right earbud is above a threshold (e.g., a percentage). Additionally, or alternatively, the electronic device may determine to switch between the primary and secondary earbuds based on the user switching from using the earbuds in a mono mode to a stereo mode or from the stereo mode to the mono mode.

At 408, the electronic device may check whether the user's preferred earbud has a lower battery than the user's non-preferred earbud. For example, if the user prefers to use the left earbud in the mono mode, the electronic device may check whether the left earbud has a lower battery than the right earbud. Alternatively, if the user prefers to use the right earbud in the mono mode, the electronic device may check whether the right earbud has a lower battery than the left earbud. In some examples, the electronic device may be equipped with the ability to monitor the battery levels of the earbuds while a user is wearing the earbuds, and determine a potential difference between the battery levels of the earbuds. Additionally, or alternatively, the electronic device may determine the battery levels based on receiving an indication of the battery levels. For example, a user may store the earbuds in a charging case when not in use, where the charging case may measure the battery levels of the earbuds and provide the battery levels to the electronic device (given the electronic device and the charging case are connected via a wired connection or a wireless connection such as Bluetooth).

At 410, if the user's preferred earbud has a lower battery level than the user's non-preferred earbud, then the electronic device may switch the primary and secondary earbuds. For example, if the left earbud is initially the primary earbud and the right earbud is initially the secondary earbud for the stereo mode, then the electronic device may switch the earbuds such that the right earbud is the primary earbud and the left earbud is the secondary earbud for subsequent audio communication. Alternatively, if the right earbud is initially the primary earbud and the left earbud is initially the secondary earbud for the stereo mode, then the electronic device may switch the earbuds such that the left earbud is the primary earbud and the right earbud is the secondary earbud for subsequent audio communication. In some examples, if the electronic device switches the primary and secondary earbuds, the electronic device may do so based on a triggering event (e.g., at an opportune time such as the completion of a song or a pause in a phone call). Switching the earbuds in this way will ensure that the battery levels of the earbuds deplete more evenly, providing the user more listening time and a higher-quality stereo listening experience.

Alternatively, at 412, if the user's preferred earbud has a lower battery level than the user's non-preferred earbud, then the electronic device may refrain from switching the primary and secondary earbuds. For example, if the left earbud is initially the primary earbud and the right earbud is initially the secondary earbud for the stereo mode, then the electronic device may maintain the left earbud as the primary earbud and the right earbud as the secondary earbud. After some period of time, the electronic device may again check if a switch between the primary and secondary earbuds is required based on the difference between the battery levels of the earbuds (e.g., repeat 406 and 408).

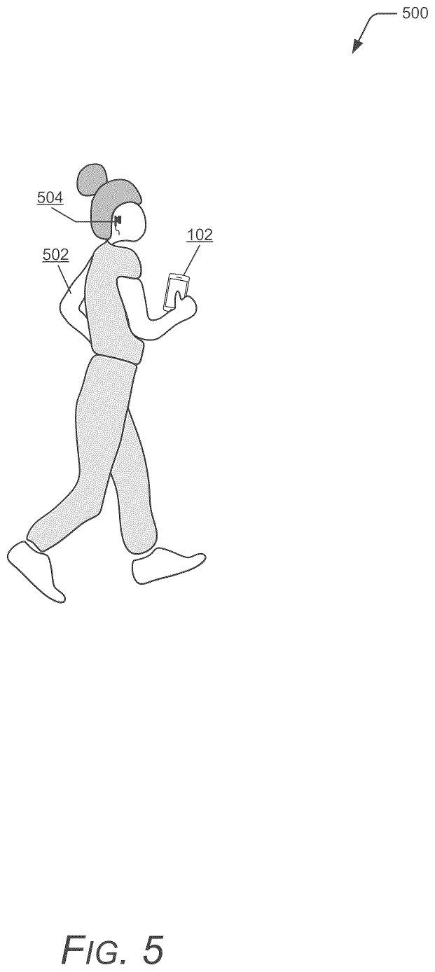

FIG. 5 illustrates an example of a use case 500 for a wearable audio communication device implementing the techniques discussed herein. In the use case 500, a user 502 may take an electronic device 102 (e.g., a smartphone, a smartwatch, etc.) and a wearable audio communication device, such as wireless earbuds, on her daily jogs. The earbuds may connect to the electronic device 102 (e.g., via Bluetooth) and allow the user 502 to listen to music take phone calls during a jog. In some cases, the earbuds may include a first earbud 504 and a second earbud, which may have run out of battery. For example, on a previous job, the user 502 may have listened to music in a mono mode using only the second earbud, such that the second earbud ran out of battery while the first earbud 504 stayed charged. Now, given the user 502 did not charge the earbuds in the meantime, the second earbud is out of battery and the user can only listen to music or take phone calls in a mono mode using only the first earbud 504. As such, the user 502 may miss out on a high-quality listening experience.

Alternatively, both earbuds may be charged when the user 502 begins her jog. The user 502 may want to be aware of her surroundings while on the jog, so the user 502 may only wear one earbud, the first earbud 504, in a mono mode during her jog (e.g., if the user 502 jogs along a road, she may wish to listen for cars while also listening to music). In such cases, the battery level of the first earbud 504 may deplete by the time the user 502 is home from the jog, but the second earbud may still have a relatively high battery level.

In such cases, to ensure the first earbud 504 is neither significantly more or less charged than the second earbud, the electronic device 102 may employ the techniques described herein to balance the battery levels between the earbuds. For example, if the user 502 typically jogs with only the first earbud 504 in a mono mode, then the electronic device may select the second earbud to be a primary earbud next time the user 502 uses the earbuds in a stereo mode.

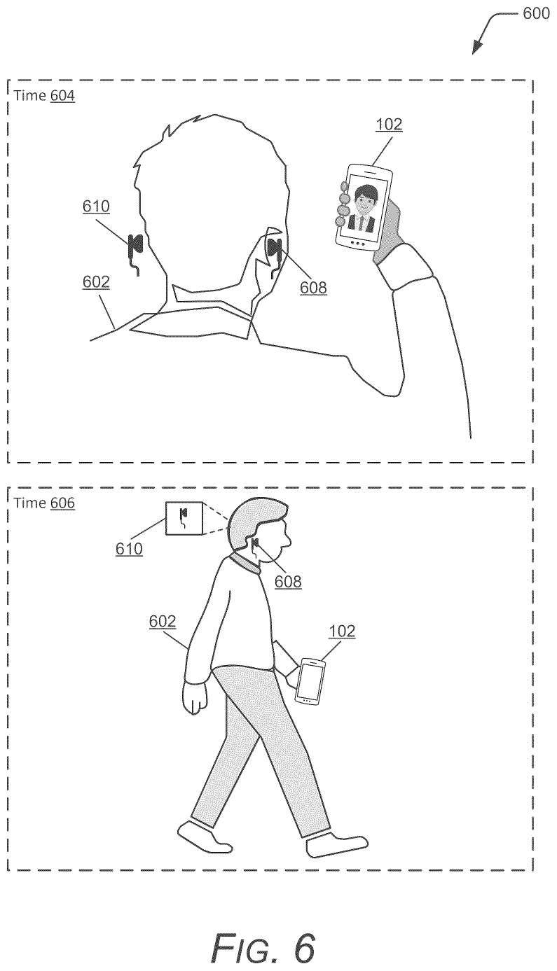

FIG. 6 illustrates an example of a use case 600 for a wearable audio communication device implementing the techniques discussed herein. In the use case 600, a user 602 may use an electronic device 102 (e.g., a smartphone, a smartwatch, a tablet, etc.) and a wearable audio communication device, such as wireless earbuds, at different times, a time 604 and a time 606. For example, at a time 604, the user 602 may watch a web series on the electronic device 102 with the earbuds. The earbuds may connect to the electronic device 102 (e.g., via Bluetooth) and allow the user 602 to listen to the web series without disturbing anyone around him. In some cases, the earbuds may include a first earbud 608 (e.g., a right earbud) and a second earbud 610 (e.g., a left earbud). The user 602 may listen to the web series using both earbuds in a stereo mode, where audio is supplied to both the first earbud 608 and the second earbud 610 through right and left audio channels, respectively. Unbeknownst to the user 602, the default behavior for the earbuds may be for the first earbud 608 to be the primary earbud (connected to the electronic device 102 to supply audio to the second earbud 610, the secondary earbud), such that the battery of the first earbud 608 may have gone down more than the battery of the second earbud 610.

At the time 606, subsequent to the time 604, the user 602 may have a phone call for work. If the user 602 does not need to be present in the office to take the phone call, the user 602 may take a walk during the call. On these walks, the user 602 may prefer to use only the first earbud 608 in a mono mode such that the user may also be conscious of the road and passersby. However, given that the first earbud 608 was the preferred earbud in the previous stereo mode and if the user 602 did not charge the earbuds between the time 604 and the time 606, the first earbud 608 may run out of battery shortly into the user's walk, requiring the user to use the second earbud 610.

In such cases, to prevent the user 602 from having to rely on a non-preferred earbud during stereo mode or mono mode operations, and so that the first earbud 608 is neither significantly more or less charged than the second earbud 610, the electronic device 102 may employ the techniques described herein to balance the battery levels between the earbuds. For example, if the user 602 typically prefers to use the first earbud 608 in a mono mode while on a walk, then the electronic device 102 may select the second earbud 610 as the primary earbud and the first earbud 608 as the secondary earbud when the user 602 uses the earbuds in a stereo mode, such as at the time 604.

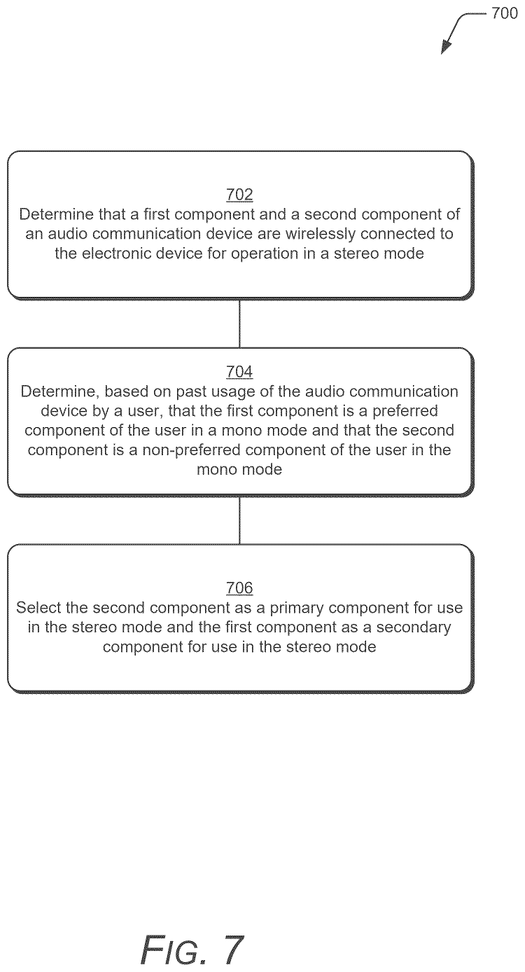

FIG. 7 illustrates an example process 700 for implementing the techniques discussed herein in accordance with one or more embodiments. The process 700 is carried out by a usage module, a component selection module, and a device communication module of an electronic device and first and second components of an audio communication device, such as the usage module 108, the component selection module 110, and the device communication module 112 of the electronic device 102 and the first component 114 and the second component 116 of the audio communication device 104 of FIG. 1, and can be implemented in software, firmware, hardware, or combinations thereof. The process 700 is shown as a set of acts and is not limited to the order shown for performing the operations of the various acts.

In the process 700, an electronic device may determine that a first component and a second component of an audio communication device are wirelessly connected to the electronic device for operation in a stereo mode (act 702). The audio communication device may be wireless earbuds, and the first component (e.g., the first component 114) may correspond to one of a left earbud or a right earbud, and the second component (e.g., the second component 116) may correspond to the other of the left or right earbud. The electronic device and the components of the audio communication device may be connected via Bluetooth.

Based on past usage of the audio communication device by a user, the electronic device may determine that the first component is a preferred component of the user in a mono mode and that the second component is a non-preferred component of the user in the mono mode (act 704). In some examples, past usage data may be stored at the electronic device. In the mono mode, the user may only use one earbud (e.g., the preferred component) to listed to audio via one audio channel. As such, in the mono mode, a battery level of the preferred component may begin to decrease while a battery level of the non-preferred component may stay the same.

The electronic device may select the second component as a primary component for use in the stereo mode and the first component as a secondary component for use in the stereo mode (act 706). The primary component may connect to the electronic device directly, receive audio through left and right audio channel, and sync with a secondary component to provide audio through both of the channels. So, the primary component may use more battery than the secondary component in the stereo mode because of the primary component's connection to the electronic device. Instead of maintaining the preferred component in the mono mode as the primary component for use in the stereo mode, in which case the preferred component would lose significantly more battery than the non-preferred component in the mono mode (secondary component in the stereo mode), the electronic device may switch the components such that the non-preferred component in the mono mode becomes the primary component in the stereo mode. This may balance the battery levels of the components as one of the components is using more battery than the other at different times.

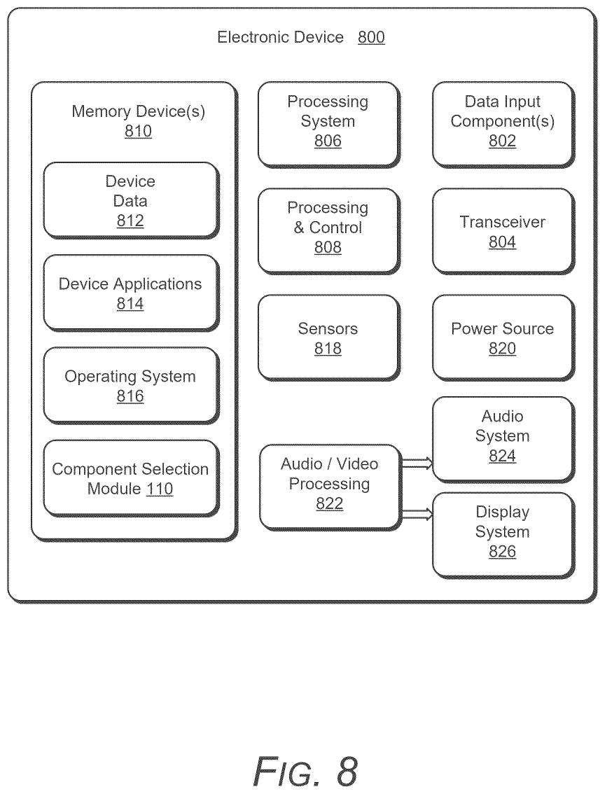

FIG. 8 illustrates various components of an example electronic device that can implement embodiments of the techniques discussed herein. The electronic device 800 can be implemented as any of the devices described with reference to the previous Figures, such as any type of client device, mobile phone, tablet, computing, communication, entertainment, gaming, media playback, or other type of electronic device. For example, the electronic device 800 may be an electronic device 102 that includes a component selection module 110, as described with reference to FIG. 1.

The electronic device 800 includes one or more data input components 802 via which any type of data, media content, or inputs can be received such as user-selectable inputs, messages, music, television content, recorded video content, and any other type of text, audio, video, or image data received from any content or data source. The data input components 802 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 802 may also include various other input components such as microphones, touch sensors, touchscreens, keyboards, and so forth.

The electronic device 800 includes communication transceivers 804 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The electronic device 800 includes a processing system 806 of one or more processors (e.g., any of microprocessors, controllers, and the like) or a processor and memory system implemented as a system-on-chip (SoC) that processes computer-executable instructions. The processing system 806 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 808. The electronic device 800 may further include any type of a system bus or other data and command transfer system that couples the various components within the device. A system bus can include any one or combination of different bus structures and architectures, as well as control and data lines.

The electronic device 800 also includes computer-readable storage memory devices 810 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 810 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The electronic device 800 may also include a mass storage media device.

The computer-readable storage memory device 810 provides data storage mechanisms to store the device data 812, other types of information or data, and various device applications 814 (e.g., software applications). For example, an operating system 816 can be maintained as software instructions with a memory device and executed by the processing system 806 to cause the processing system 806 to perform various acts. The device applications 814 may also include a device manager, such as any form of a control application, software application, signal-processing and control module, code that is native to a particular device, a hardware abstraction layer for a particular device, and so on.

The electronic device 800 can also include one or more device sensors 818, such as any one or more of an ambient light sensor, a proximity sensor, a touch sensor, an infrared (IR) sensor, accelerometer, gyroscope, thermal sensor, audio sensor (e.g., microphone), and the like. The electronic device 800 can also include one or more power sources 820, such as when the electronic device 800 is implemented as a mobile device. The power sources 820 may include a charging or power system, and can be implemented as a flexible strip battery, a rechargeable battery, a charged super-capacitor, or any other type of active or passive power source.

The electronic device 800 additionally includes an audio or video processing system 822 that generates one or both of audio data for an audio system 824 and display data for a display system 826. In accordance with some embodiments, the audio/video processing system 822 is configured to receive call audio data from the transceiver 804 and communicate the call audio data to the audio system 824 for playback at the electronic device 800. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for managing usage of components of an audio communication device in stereo and mono modes have been described in language specific to features or methods, the subject of the appended claims is not necessarily limited to the specific features or methods described. Rather, the specific features and methods are disclosed as example implementations of techniques for implementing managing usage of components of an audio communication device in stereo and mono modes. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a first device, including: at least one memory; and at least one processor coupled with the at least one memory and configured to cause the first device to: determine that a first component and a second component of an audio communication device are wirelessly connected to the electronic device for operation in a stereo mode; determine, based at least in part on past usage of the audio communication device by a user, that the first component is a preferred component of the user in a mono mode and that the second component is a non-preferred component of the user in the mono mode; and select the second component as a primary component for use in the stereo mode and the first component as a secondary component for use in the stereo mode.

In some aspects, the techniques described herein relate to a first device, wherein the at least one processor is configured to cause the first device to: select the second component as the primary component for use in the stereo mode based at least in part on a battery level of the first component being lower than a battery level of the second component.

In some aspects, the techniques described herein relate to a first device, wherein the primary component is wirelessly connected to the electronic device and transmits audio wirelessly to the secondary component in the stereo mode.

In some aspects, the techniques described herein relate to a first device, wherein the secondary component receives the audio wirelessly from the primary component rather than being wirelessly connected to the electronic device.

In some aspects, the techniques described herein relate to a first device, wherein the primary component is wirelessly connected to the electronic device and is the only component of the audio communication device used in the mono mode.

In some aspects, the techniques described herein relate to a first device, wherein the at least one processor is configured to cause the first device to: determine a difference between a battery level of the first component and a battery level of the second component while the user uses the audio communication device in the stereo mode; and select the first component as the primary component for use in the stereo mode based at least in part on the battery level of the second component being lower than the battery level of the first component.

In some aspects, the techniques described herein relate to a first device, wherein the first component is selected as the primary component for use in the stereo mode based at least in part on the difference between the battery levels being above a threshold.

In some aspects, the techniques described herein relate to a first device, wherein the at least one processor is configured to cause the first device to: select the first component as the primary component for use in the stereo mode based on a triggering event.

In some aspects, the techniques described herein relate to a method comprising: determining that a first component and a second component of an audio communication device are wirelessly connected to the electronic device for operation in a stereo mode; determining, based at least in part on past usage of the audio communication device by a user, that the first component is a preferred component of the user in a mono mode and that the second component is a non-preferred component of the user in the mono mode; and selecting the second component as a primary component for use in the stereo mode and the first component as a secondary component for use in the stereo mode.

In some aspects, the techniques described herein relate to a method, further comprising: selecting the second component as the primary component for use in the stereo mode based at least in part on a battery level of the first component being lower than a battery level of the second component.

In some aspects, the techniques described herein relate to method, wherein the primary component is wirelessly connected to the electronic device and transmits audio wirelessly to the secondary component in the stereo mode.

In some aspects, the techniques described herein relate to a method, wherein the secondary component receives the audio wirelessly from the primary component rather than being wirelessly connected to the electronic device.

In some aspects, the techniques described herein relate to a method, wherein the primary component is wirelessly connected to the electronic device and is the only component of the audio communication device used in the mono mode.

In some aspects, the techniques described herein relate to a method, further comprising: determining a difference between a battery level of the first component and a battery level of the second component while the user uses the audio communication device in the stereo mode; and selecting the first component as the primary component for use in the stereo mode based at least in part on the battery level of the second component being lower than the battery level of the first component.

In some aspects, the techniques described herein relate to a method, wherein the first component is selected as the primary component for use in the stereo mode based at least in part on the difference between the battery levels being above a threshold.

In some aspects, the techniques described herein relate to a method, further comprising: selecting the first component as the primary component for use in the stereo mode based on a triggering event.

In some aspects, the techniques described herein relate to a system, including: a processing system to: determine that a first component and a second component of an audio communication device are wirelessly connected to the electronic device for operation in a stereo mode; determine, based at least in part on past usage of the audio communication device by a user, that the first component is a preferred component of the user in a mono mode and that the second component is a non-preferred component of the user in the mono mode; and select the second component as a primary component for use in the stereo mode and the first component as a secondary component for use in the stereo mode.

In some aspects, the techniques described herein relate to a system, wherein the processing system is further configured to: select the second component as the primary component for use in the stereo mode based at least in part on a battery level of the first component being lower than a battery level of the second component.

In some aspects, the techniques described herein relate to a system, wherein the primary component is wirelessly connected to the electronic device and transmits audio wirelessly to the secondary component in the stereo mode.

In some aspects, the techniques described herein relate to a system, wherein the secondary component receives the audio wirelessly from the primary component rather than being wirelessly connected to the electronic device.

What is claimed is:

1. An electronic device, comprising:
at least one memory; and
at least one processor coupled with the at least one memory and configured to cause the electronic device to:
determine that a first component and a second component of an audio communication device are wirelessly connected to the electronic device for operation in a stereo mode;
determine, based at least in part on past usage of the audio communication device by a user, that the first component is a preferred component of the user in a mono mode and that the second component is a non-preferred component of the user in the mono mode; and
select the second component as a primary component for use in the stereo mode and the first component as a secondary component for use in the stereo mode.

2. The electronic device of claim 1, wherein the at least one processor is further configured to cause the electronic device to:
select the second component as the primary component for use in the stereo mode based at least in part on a battery level of the first component being lower than a battery level of the second component.

3. The electronic device of claim 1, wherein the primary component is wirelessly connected to the electronic device and transmits audio wirelessly to the secondary component in the stereo mode.

4. The electronic device of claim 3, wherein the secondary component receives the audio wirelessly from the primary component rather than being wirelessly connected to the electronic device.

5. The electronic device of claim 1, wherein the primary component is wirelessly connected to the electronic device and is the only component of the audio communication device used in the mono mode.

6. The electronic device of claim 1, wherein the at least one processor is further configured to cause the electronic device to:
determine a difference between a battery level of the first component and a battery level of the second component while the user uses the audio communication device in the stereo mode; and
select the first component as the primary component for use in the stereo mode based at least in part on the battery level of the second component being lower than the battery level of the first component.

7. The electronic device of claim 6, wherein the first component is selected as the primary component for use in the stereo mode based at least in part on the difference between the battery levels being above a threshold.

8. The electronic device of claim 6, wherein the at least one processor is configured to cause the electronic device to:
select the first component as the primary component for use in the stereo mode based on a triggering event.

9. A method at an electronic device, the method comprising:
determining that a first component and a second component of an audio communication device are wirelessly connected to the electronic device for operation in a stereo mode;
determining, based at least in part on past usage of the audio communication device by a user, that the first component is a preferred component of the user in a mono mode and that the second component is a non-preferred component of the user in the mono mode; and
selecting the second component as a primary component for use in the stereo mode and the first component as a secondary component for use in the stereo mode.

10. The method of claim 9, further comprising:
selecting the second component as the primary component for use in the stereo mode based at least in part on a battery level of the first component being lower than a battery level of the second component.

11. The method of claim 9, wherein the primary component is wirelessly connected to the electronic device and transmits audio wirelessly to the secondary component in the stereo mode.

12. The method of claim 11, wherein the secondary component receives the audio wirelessly from the primary component rather than being wirelessly connected to the electronic device.

13. The method of claim 9, wherein the primary component is wirelessly connected to the electronic device and is the only component of the audio communication device used in the mono mode.

14. The method of claim 9, further comprising:
determining a difference between a battery level of the first component and a battery level of the second component while the user uses the audio communication device in the stereo mode; and
selecting the first component as the primary component for use in the stereo mode based at least in part on the battery level of the second component being lower than the battery level of the first component.

15. The method of claim 14, wherein the first component is selected as the primary component for use in the stereo mode based at least in part on the difference between the battery levels being above a threshold.

16. The method of claim 14, further comprising:
selecting the first component as the primary component for use in the stereo mode based on a triggering event.

17. A system, comprising:
a processing system to:
determine that a first component and a second component of an audio communication device are wirelessly connected to an electronic device for operation in a stereo mode;
determine, based at least in part on past usage of the audio communication device by a user, that the first component is a preferred component of the user in a mono mode and that the second component is a non-preferred component of the user in the mono mode; and
select the second component as a primary component for use in the stereo mode and the first component as a secondary component for use in the stereo mode.

18. The system of claim 17, wherein the processing system is further configured to:
select the second component as the primary component for use in the stereo mode based at least in part on a battery level of the first component being lower than a battery level of the second component.

19. The system of claim 17, wherein the primary component is wirelessly connected to the electronic device and transmits audio wirelessly to the secondary component in the stereo mode.

20. The system of claim 19, wherein the secondary component receives the audio wirelessly from the primary component rather than being wirelessly connected to the electronic device.
